(19) United States
(12) Patent Application Publication
(10) Pub. No.: US 2026/0170091 A1
(43) Pub. Date: Jun. 18, 2026

(54) POST-FILTERING DATA EXPANSION

(71) Applicant: Optum Services (Ireland) Limited, Dublin (IE)

(72) Inventors: Theodoros CHATZIDIMITRIOU, Dublin (IE); Richard MCALEAVEY, Balscadden (IE); Michela FRANCESCHETTI, Dublin (IE)

(21) Appl. No.: 18/980,883

(22) Filed: Dec. 13, 2024

(51) Int. Cl. G06F 18/2431; G06F 18/21; G06F 18/2413

(52) U.S. Cl. CPC G06F 18/2431; G06F 18/217; G06F 18/2413

(57) ABSTRACT

Various embodiments of the present disclosure provide a data filtering and expansion technique that improves the functionality of a computer in various aspects. The techniques comprise generating a target object embedding for an unlabeled data object within a set of data objects that comprise a subset of unlabeled data objects and a subset of labeled data objects. The techniques comprise generating an embedding similarity score for the unlabeled data object and extracting the unlabeled data object from the subset of unlabeled data objects based on a comparison between the embedding similarity score and a quantile similarity threshold. The techniques comprise providing an expansion message that comprises the unlabeled data object to expand an initially filtered set of results.

### BACKGROUND

In big data scenarios, computer systems reduce data into manageable units of information by applying various data filtering techniques that range in complexity. These comprise machine learning-based techniques (e.g., classification, regression), rule-based techniques, and combinations thereof. The goal of each technique is to filter big data by extracting units of information that are most relevant for a particular scenario in the most cost (e.g., in terms of time and processing resources) effective manner. To achieve this goal for a particular scenario, a technique is selected that achieves a most applicable balance between relevance (e.g., used to limit an amount of extracted data), data coverage (e.g., used to expand an amount of extracted data), and processing efficiency (e.g., in terms of time and processing resources). However, there are several technical challenges that limit the ability of traditional data filtering mechanisms from achieving a desired balance between relevance and data coverage in a cost (e.g., in terms of time and processing resources) effective manner.

Traditional deterministic rule-based algorithms, for example, may require extensive manual configuration and maintenance, making them costly to implement and update. Additionally, such systems are limited in their ability to adapt to new patterns or variations in data, as they require exact matches to pre-programmed criteria. The effectiveness of conventional rule-based systems is further constrained by their rigid architecture. When attempting to expand the scope of analysis, system administrators must either broaden existing rules, potentially increasing false positives, or create new rules, which requires significant development resources. This technical limitation results in reduced efficiency and increased computational overhead as systems process large volumes of data through multiple discrete rule sets. Machine learning models face similar challenges as they may require training on specific datasets that are targeted for particular relevancy criteria. Traditionally, machine learning-based filtering techniques train models using labeled training data with binary indicators that identify whether a particular training entry is relevant for a particular scenario. By doing so, machine learning based solutions are traditionally trained to optimize relevance at the cost of data coverage.

### BRIEF DESCRIPTION OF THE DRAWINGS

FIG. 1 depicts a block diagram of an example architecture in accordance with some embodiments of the present disclosure.

FIG. 2 depicts a block diagram of an example predictive data analysis computing entity in accordance with some embodiments of the present disclosure.

FIG. 3 depicts a block diagram of an example client computing entity in accordance with some embodiments of the present disclosure.

FIG. 4 depicts a dataflow diagram of data filtering and expansion technique in accordance with some embodiments of the present disclosure.

FIG. 5 depicts a dataflow diagram of an example expansion framework in accordance with some embodiments of the present disclosure.

FIG. 6 depicts a dataflow diagram of an embedding technique in accordance with some embodiments of the present disclosure.

FIG. 7 depicts a flowchart diagram of an example data filtering and expansion process in accordance with some embodiments of the present disclosure.

### DETAILED DESCRIPTION

Various embodiments of the present disclosure provide a data filtering pipeline that improves traditional machine learning techniques by layering in a data expansion framework configured to expand data coverage of a machine learning technique without reducing the performance (e.g., in terms of processing efficiency and accuracy) of the underlying models. To do so, some embodiments of the present disclosure provide a data filtering pipeline that comprises connected, filtering and expansion sub-tasks configured to sequentially filter and expand data from an incoming dataset. The filtering sub-task, for example, may be configured to extract data objects from an incoming dataset in a manner that optimizes relevancy by reducing data coverage (e.g., focusing on specific subset of data rather than the data as a whole). In a sequential operation, the expansion sub-task may be optimized to expand the outputs of a filtering sub-task based on vector comparisons between vectors generated for the outputs of the filtering sub-task and vectors generated for the incoming dataset. In this manner, the data filtering pipeline synthesizes competing sub-tasks into a single pipeline that balances between competing goals of traditional data filtering techniques. This, in turn, enables improved performance (e.g., in terms of accuracy and speed) of each of the individual sub-tasks by siloing the sub-tasks to a particular stage of an end-to-end data filtering pipeline. Ultimately, this improves the functionality of a computer in terms of speed, accuracy, and data coverage with respect to data filtering, among other computer functionalities, by improving traditional machine learning-based filtering mechanisms.

In some embodiments, the data filtering pipeline provides an improvement to machine learning training by separating a traditionally multi-goal task into a multi-stage operation. For example, by separating a filtering problem into two sub-tasks, the data filtering pipeline enables the specialized training of different machine learning models for competing goals (e.g., relevancy and data coverage) of a complex task. This, in turn, enables the generation and maintenance of targeted training data to improve the performance of a model with respect to a portion of a staged data filtering task and reduces the complexity of subsequent training operations.

In addition, or alternatively, the data filtering pipeline provides a specific arrangement of models that enable the use of different machine learning architectures to replace traditional rule-based filtering approaches without decreasing the processing speed in big data scenarios. For example, traditional deterministic rules may be configured that capture a subset of relevant data objects for specific scenarios. However, they fail to adapt to new patterns and effectively incorporate findings from external sources, leading to limited data coverage or reduced relevancy predictions. Using the techniques of the present disclosure, rule-based filtering approaches may be replaced with machine learning classifiers and/or encoders to increase their flexibility and/or adaptability to new scenarios. For example, by separating the filtering problem into two sub-tasks, machine learning classifiers may be effectively trained to replace the relevancy predictions of rule-based filtering approaches with an adaptable solution. At the same time, a data expansion framework may leverage machine learning encoders that may be effectively trained to replace the data coverage criteria of the rule-based filtering approaches to enable the specialization of the machine learning classifiers for a relevancy prediction task.

By way of example, the data expansion framework may leverage a machine learning encoder and/or a quantile-based embedding filtering technique to generated embeddings for filtered outputs in an embedding space and selectively expand the filtered outputs based on determining embeddings within region(s) of the embedding space surrounding the filtered output embeddings (e.g., within a threshold distance of the embeddings). The outputs may be generated using a synthesized embedding approach that creates precise numerical representations of data objects that account for the individual attributes of the data objects and the attributes of object cohorts to which the data objects belong. In this way, embedding similarities (e.g., embeddings within a region surrounding the filtered output embeddings) within an embedding space may account for and expand on the nuances within specific cohorts of data objects to improve similarity predictions. Ultimately, the data expansion framework may integrate the similarity prediction with a quantile-based filtering technique to selectively expand filtering outputs based on a predicted importance with respect to a particular scenario. This allows for data expansion from filtered outputs that may be tailored to particular scenarios.

Examples of technologically advantageous embodiments of the present disclosure comprise (i) improved data expansion frameworks that are configurable based on any type of existing data filtering technique without a tradeoff in the performance of the data filtering technique, such that they improve the data filtering capability of a computer with respect to both filtering coverage, speed, and accuracy, (ii) improved distribution of filtering functionality that enables adaptive filtering through a user interface in near-real time to improve message filtering speeds within a computer, (iii) improved interface and implementation for augmenting filtering results using a data expansion framework unique to computers that improves the machine learning training functionality of a computer through expanded training datasets, among other aspects of the present disclosure. Other technical improvements and advantages may be realized by one of ordinary skill in the art.

### I. OVERVIEW OF EMBODIMENTS

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

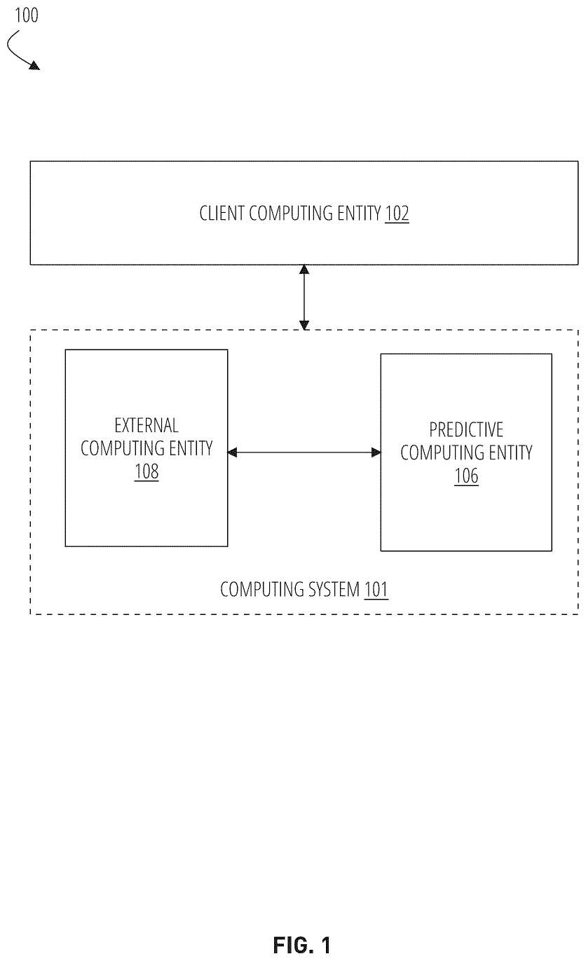

FIG. 1 depicts a block diagram of an example architecture 100 in accordance with some embodiments of the present disclosure. The architecture 100 comprises a computing system 101 configured to receive a request, such as an expansion request, and/or the like, from client computing entity(ies) 102, process the request, and provide a response, such as an expansion response, to the client computing entities 102. The example architecture 100 may be used in a plurality of domains and not limited to any specific application as disclosed herewith. The plurality of domains may comprise healthcare, industrial, manufacturing, computer security, and/or the like to name a few.

In some embodiments, the computing system 101 may communicate with at least one of the client computing entities 102 using one or more communication networks. Examples of communication networks comprise any wired or wireless communication network comprising, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., request handling, filtering and/or expansion techniques) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as embedding datastores, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

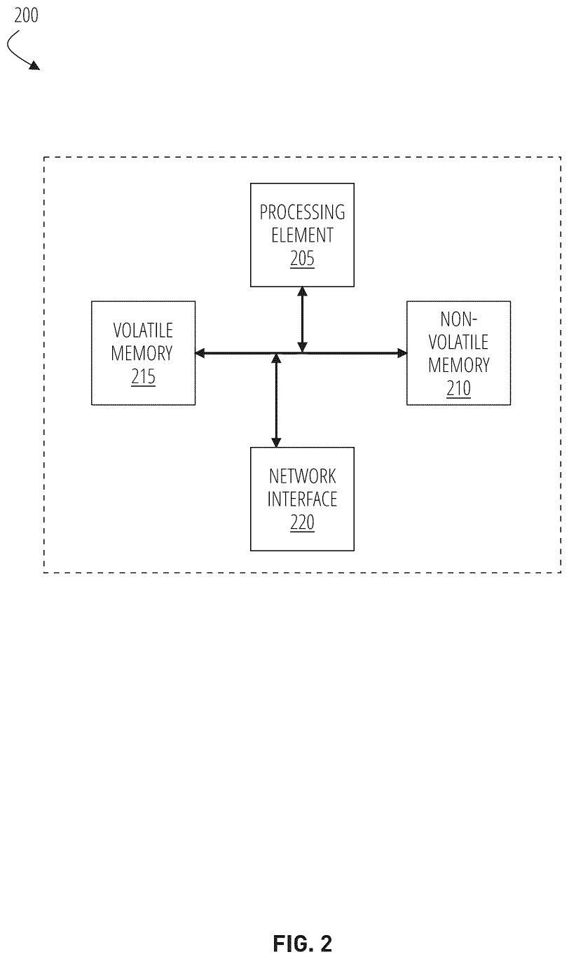

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), as discussed above.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium comprising random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (comprising various levels), flash memory, register memory, and/or the like. It will be appreciated that where embodiments are described to use a computer-readable storage medium, other types of computer-readable storage media may be substituted for or used in addition to the computer-readable storage media described above.

As will be recognized, the non-volatile memory 210 and/or the volatile memory 215 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components comprising, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (comprising volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

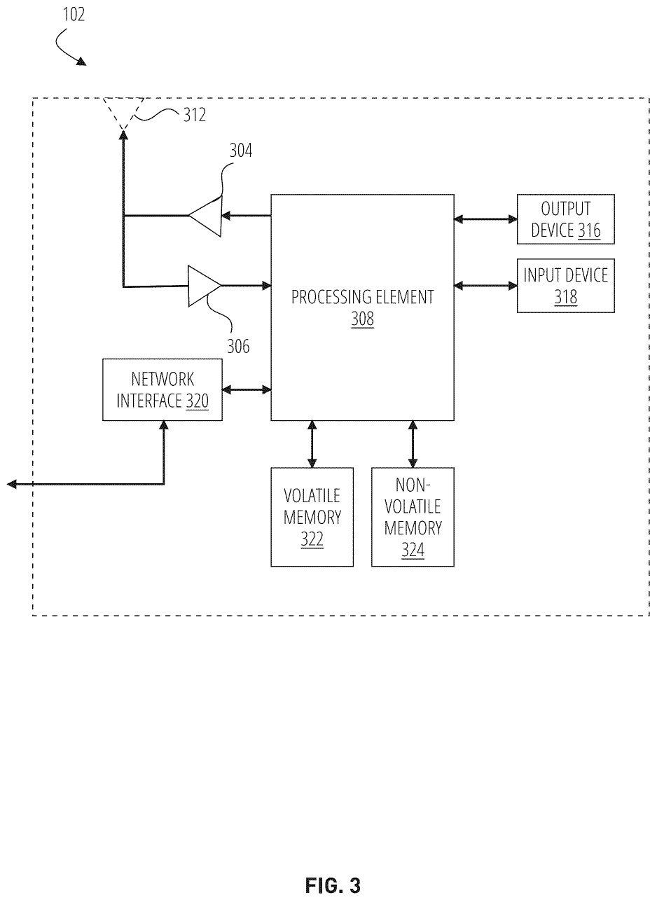

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., comprising executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, comprising Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, comprising cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies comprising RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. EXAMPLE SYSTEM OPERATIONS

As indicated, various embodiments of the present disclosure make important technical contributions to computer functionality, such as message filtering systems, big data analysis, machine learning training, among others. In particular, systems and methods are disclosed herein that implement machine learning-based filtering and data expansion techniques to improve data retrieval, storage, and matching operations in high-dimensional computing environments. By doing so, the machine learning-based filtering and data expansion techniques of the present disclosure enable improved data retrieval and data storage process that, when executed on a computer, improves computer resource allocation. This, in turn, may improve the functionality of a computer with respect to various computing tasks, comprising message filtering, machine learning training, network communication, and the like.

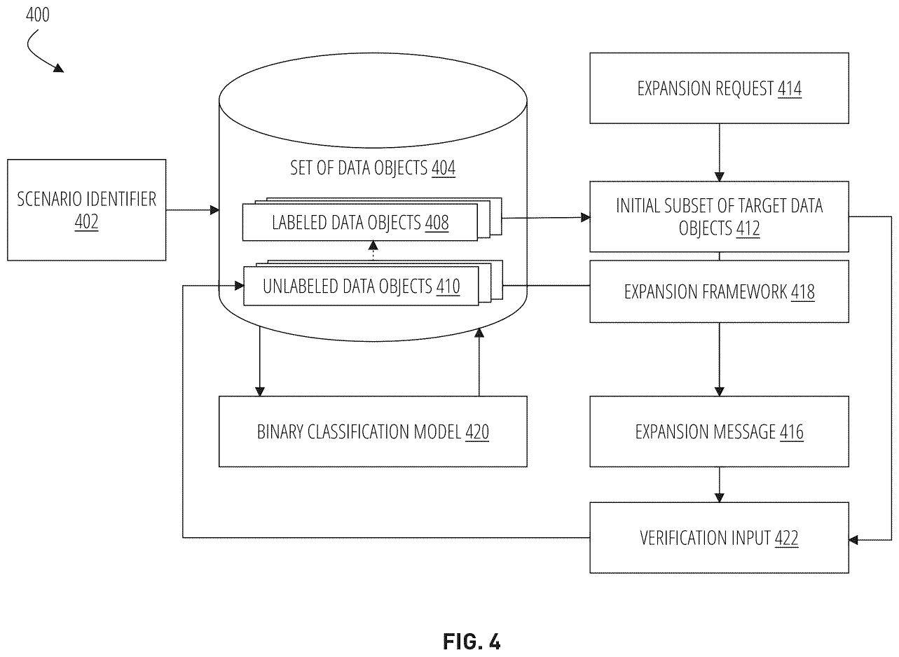

FIG. 4 depicts a dataflow diagram 400 of data filtering and expansion technique in accordance with some embodiments of the present disclosure. The data filtering and expansion technique may comprise sequential filtering and expansion sub-tasks that may be implemented by a computing system, such as the computing system 101 of the present disclosure, to filter data from an incoming dataset, while reducing information loss. In some examples, the data filtering and expansion technique may be applied at a scenario-level of a robust dataset to individually filter and expand data for up to each of a set of requested scenarios. By doing so, the data filtering and expansion technique enables targeted filtering requests that may apply scenario-specific machine learning classifiers to improve the accuracy (e.g., in terms of relevance, prediction accuracy) of the data filtered from a robust dataset. In addition, or alternatively, the scenario-level application of the data filtering and expansion technique enables an expansion framework 418 that may be leveraged to supplement any data filtering technique to improve the comprehensiveness of filtered data objects. This, in turn, allows for a stricter application of data filtering tools by overcoming traditional information loss disadvantages of such tools.

More particularly, in some embodiments, the computing system 101 receives a scenario identifier 402. The computing system 101 may determine a set of data objects 404 based on the scenario identifier 402. In some examples, the set of data objects 404 may comprise a subset of unlabeled data objects 410 and/or a subset of labeled data objects 408. For example, a labeled data object of the subset of labeled data objects 408 may be assigned (i) a binary classification label and/or (ii) a quantile rating that identifies a relative prioritization of the labeled data object relative to the subset of labeled data objects 408.

In some embodiments, the scenario identifier 402 is a value (e.g., numeric, alphabetic, alpha-numeric) that corresponds to a specific analytical context with respect to a prediction domain. For instance, the scenario identifier 402 may correspond to a particular query use case in a prediction domain. In this regard, a scenario identifier 402 may be domain specific. For instance, in a clinical domain example, a scenario identifier 402 may correspond to one of a set of overpayment scenarios for a medical claim, and/or the like. As another example, in a networking domain, a scenario identifier 402 may correspond to one of a set of network congestion scenarios.

In some examples, a scenario identifier 402 may enable organizing and categorizing data for targeted analysis within computer systems. A scenario identifier 402 may be implemented as a unique code and/or label stored in a database, allowing for efficient indexing and/or retrieval of scenario-specific information. In a relational database system, scenario identifiers 402, for example, may comprise a primary key linking various tables containing scenario-related data objects. In this manner, a scenario identifier 402 may partition large datasets into manageable, scenario-specific sets of data objects 404 to improve query performance and reduce computational overhead when processing data. In addition, or alternatively, a scenario identifier 402 may enable parallel processing of data across multiple scenarios. For example, by associating each data object with one or more scenario identifiers 402, a distributed computing system may efficiently allocate resources to process different scenarios concurrently. In some examples, in each scenario, a different set of classifiers and/or encoding approaches may be leveraged to tailor a data filtering techniques to a specific context.

In some embodiments, the set of data objects 404 comprises a plurality of data objects that correspond to a particular scenario identifier 402. The set of data objects 404 may comprise a combination of labeled data objects 408 and unlabeled data objects 410, where the labeled data objects 408 have undergone some form of processing or classification. For example, the labeled data objects 408 may comprise an initial subset of target data objects 412 that is distinguished from a subset of unlabeled data objects 410 by a data filtering technique.

In some examples, the set of data objects 404 may comprise a data structure, such as an array, linked list, graph, and/or like that defines a relationship between a plurality of data objects. For instance, a set of data objects 404 may comprise a table, a collection of related tables, a collection of nodes, and/or the like, where up to each row and/or node corresponds to a data object and up to each column, node attribute, and/or the like corresponds to a data attribute and/or feature of those objects.

In some examples, the set of data objects 404 may comprise training data for one or more scenario-specific machine learning models and/or input data for one or more downstream scenario-specific processing tasks. For instance, the division between labeled data objects 408 and/or unlabeled data objects 410 within the set of data objects 404 may be leveraged to implement one or more supervised training tasks, where labeled data is used to train models and/or unlabeled data is used to test their performance or to be classified by the trained models. In addition, or alternatively, the labeled data objects 408 may comprise a subset of the set of data objects 404 that are associated with positive classification predictions from a trained model and the unlabeled data objects 410 may comprise a subset of the set of data objects 404 that are not associated with positive classification predictions.

In some examples, a set of data objects 404 may be dynamically updated on one or more update frequencies. By way of example, a set of data objects 404 may comprise a plurality of data objects that is aggregated from one or more data sources at a particular point in time. For example, up to each of the one or more data sources may receive, store, and/or generate one or more data objects as new data becomes available. At the time of a filtering operation, the set of data objects 404 may comprise a plurality of data objects that is aggregated from a current state at up to each of the one or more data sources. In this manner, the set of data objects 404 may dynamically change over time as processing is performed and new data is uploaded to various data sources associated with a computing system 101.

In some embodiments, up to each of the set of data objects 404 is separated into an unlabeled data object of a subset of unlabeled data objects 410 and/or a labeled data object of a subset of labeled data objects 408.

In some embodiments, an unlabeled data object is a data object that is unclassified by a data filtering techniques and/or assigned a negative classification prediction from a data filtering technique indicating that the data object is irrelevant for a particular scenario. For instance, an unlabeled data object may comprise a unique identifier and/or one or more object attributes that identify one or more characteristics of the data object. For instance, the one or more object attributes may comprise one or more code attributes for a particular scenario, one or more cohort identifiers, and/or the like. In some examples, the one or more object attributes may depend on a particular scenario. By way of example, using a clinical use case, the one or more object attributes may comprise one or more code attributes that identify one or more CPT codes, ICD codes, and/or the like within a medical claim, one or more cohort identifiers that identify a health care provider associated with the claims, one or more recovery amounts, that identify a request reimbursement for the claim, and/or the like. In some examples, the unlabeled data object may comprise one or more negative classification predictions from a data filtering technique. In addition, or alternatively, an unlabeled data object may be unprocessed by the data filtering technique.

In some embodiments, a labeled data object is a data object that is classified by a data filtering technique and/or assigned a positive classification prediction from a data filtering technique indicating that the data object is relevant for a particular scenario. For instance, a labeled data object may comprise a unique identifier and/or one or more object attributes that identify one or more characteristics of the data object. For instance, the one or more object attributes may comprise one or more code attributes for a particular scenario, one or more cohort identifiers, and/or the like. In some examples, the one or more object attributes may depend on a particular scenario. By way of example, using a clinical use case, the one or more object attributes may comprise one or more code attributes that identify one or more CPT codes, ICD codes, and/or the like within a medical claim, one or more cohort identifiers that identify a health care provider associated with the claims, one or more recovery amounts, that identify a request reimbursement for the claim, and/or the like. In some examples, the labeled data object may comprise one or more positive classification predictions from a data filtering technique. In addition, or alternatively, a labeled data object may comprise a verification tag that verifies the positive classification prediction. In some examples, the verification tag may comprise an additional object attribute, such as a recovery value that describes an impact of a verified positive classification prediction, a quantile rating associated with the recovery value, and/or the like.

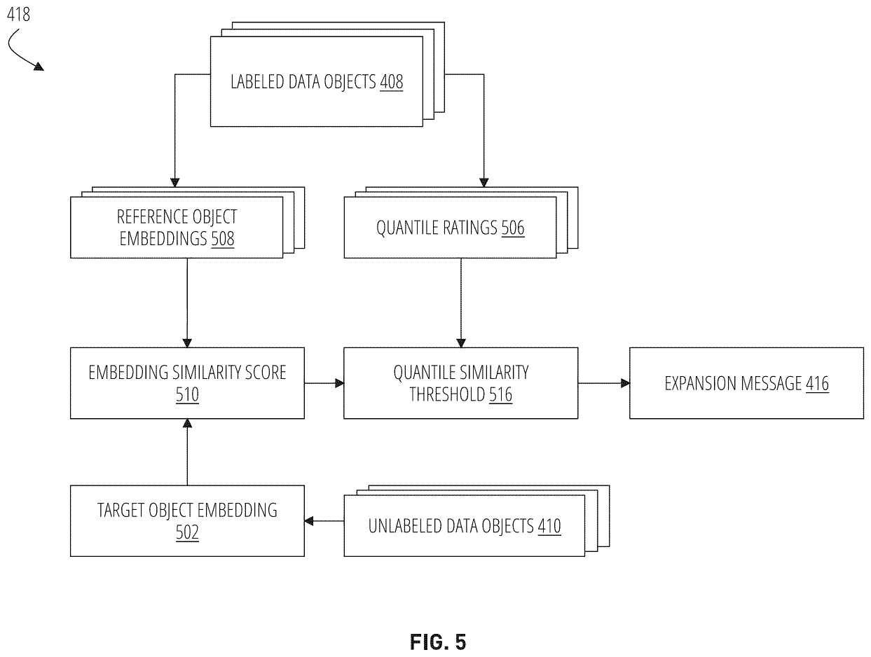

In some embodiments, the computing system 101 generates a labeled data object from an input data object of the set of data objects 404 by assigning a binary classification prediction and/or a quantile rating to the input data object. For example, the computing system 101 may generate, using the binary classification model 420, a positive classification prediction for the input data object of the set of data objects 404. In response to the positive classification prediction, the computing system 101 may determine a recovery value for the input data object and generate the labeled data object by assigning the binary classification label and a quantile rating to the input data object based on the recovery value. The quantile rating may be described in further detail herein with reference to FIG. 5.

In some embodiments, the binary classification model 420 comprises a rule-based and/or machine learning-based filtering technique configured to filter data objects from a set of data objects 404 for a particular scenario. By way of example, the binary classification model 420 may be configured, trained, and/or the like to generate a binary classification label (e.g., a binary classification, a probabilistic score) for a data object based on one or more object attributes of the data object. A binary classification model 420, for example, may comprise a computational algorithm that processes input features of a data object to output a binary classification label. The binary classification model 420 may comprise a rule-based decision tree, a sequence of rule statements, causal model, and/or one or more different machine learning models, such as logistic regression, decision trees, random forests, neural networks, and/or the like.

In some examples, the binary classification model 420 may comprise a supervised machine learning model that is trained, using a labeled training dataset, to predict an outcome for a particular scenario based on one or more object attributes. By way of example, the binary classification model 420 may comprise one or more neural networks, decision trees, random forests, and/or the like. In some examples, the binary classification model 420 may be trained, using backpropagation via gradient descent optimization, to generate a binary classification label based on a labeled training dataset comprising a set of training data objects that respectively comprise a binary training label and a set of object attributes. Once trained, binary classification models 420 may be configured to process new, data objects in real-time and/or batch mode to generate binary classification labels. By way of example, the trained binary classification model 420 may be integrated with a message interface (e.g., via a message filtering API) that may call the binary classification model 420 to filter the set of data objects 404 (e.g., as they are received) based on a set of binary classification labels respectively generated for the set of data objects 404.

In some embodiments, the binary classification label comprises a tag assigned to a data object indicating whether it has been previously processed and/or meets or exceeds one or more scenario-specific criteria. By way of example, a binary classification label may comprise a Boolean flag, binary value (e.g., 0 or 1), and/or probabilistic value that may represent a relevance of data object to a particular scenario. In some examples, a binary classification label may be leveraged to filter data objects for the particular scenario by focusing on a subset of labeled data objects 408 (e.g., assigned a positive classification prediction) as an initial subset of target data objects 412. A binary classification label may be scenario specific and may correspond to a filtering task of a data filtering and expansion technique. By way of example, using the clinical example, a binary classification label may indicate likelihood that a medical claim comprises an overpayment. By way of example, in the context of claim auditing, a binary classification model 420 may be trained to predict whether a claim is likely to contain an overpayment that could be verified through a manual auditing process. In such a case, a positive classification prediction may indicate that a data object is likely to comprise an overpayment and a negative classification prediction may indicate that the data object in unlikely to comprise an overpayment.

In some embodiments, a binary classification label is verified by a verification input 422 to convert an unlabeled data object to a labeled data object. A verification input 422, for example, may comprise user input and/or an automated input that identifies an accuracy of a positive classification prediction. For instance, in a clinical use case, a verification input 422 may comprise auditing data for a particular data object indicating that the data object comprises an overpayment. In some examples, the verification input 422 may comprise one or more contextual attributes for the verification input 422, such as a recovery value.

In some embodiments, a recovery value comprises a numerical value that describes an impact of a positive classification prediction for a data object. A recovery value may be scenario specific. By way of example, the recovery value may comprise a financial impact (e.g., claim recovery) for a clinical, claim processing scenario, a storage impact (e.g., compute savings) for a messaging scenario, and/or the like.

In some embodiments, the computing system 101 generates an initial subset of target data objects 412 from the set of data objects 404 based on the scenario identifier 402. The initial subset of target data objects 412, for example, may comprise at least a portion of the subset of labeled data objects 408. In some examples, the initial subset of target data objects 412 may comprise up to each of the subset of labeled data objects 408 as constrained by an initial filtering threshold (e.g., 10, 100, 1000, etc.). In some examples, the initial filtering threshold may be configured based on a capacity (e.g., storage capacity, processing capacity) of one or more downstream processes. By way of example, the initial filtering threshold may be set based on a queue size of a downstream process.

In some embodiments, a verification input 422 may be received for up to each of the initial subset of target data objects 412. In response to the verification input 422, a labeled data object may remain in the subset of labeled data objects 408. In addition, or alternatively, in response to a non-verification input (e.g., indicating that a positive classification prediction is incorrect), a labeled data object may be removed from the initial subset of target data objects 412.

In some embodiments, the initial subset of target data objects 412 comprises a first subset of target data objects for a downstream process that meet or exceed relevancy criteria for a filtering technique. In some examples, the initial subset of target data objects 412 may satisfy one or more relevancy goals of data filtering process at the expense of data coverage. To improve the data coverage of the filtering process, an expansion request 414 may be provided that initiates an expansion framework 418 based on the subset of labeled data objects 408.

In some embodiments, in response to an expansion request 414, the computing system 101 determines an expanded subset of target data objects from the set of data objects 404. The expanded subset of target data objects, for example, may comprise at least a portion of the subset of unlabeled data objects 410. For example, the computing system 101 may apply an expansion framework 418 (e.g., described in more detail with reference to FIG. 5) to the labeled data objects 408 to extract one or more target data objects from the subset of unlabeled data objects 410. In some examples, the computing system 101 may generate an expansion message 416 that comprises the expanded subset of target data objects and response to the expansion request 414 with an expansion response that comprises the expansion message 416.

In some embodiments, the expansion request 414 comprises a request, such as an API request, to expand an initial result set for a scenario to address a data coverage goal of a data filtering process. The expansion request 414, for example, may initiate expansion framework 418 to selectively expand the initial subset of target data objects 412 based on a combination of embedding similarity scores (e.g., cosine similarity) and/or quantile similarity thresholds. For instance, an expansion request 414 may comprise a technical mechanism used to dynamically increase the scope of data filtering process beyond an initial set of results. The expansion request 414, for example, may comprise an API call (e.g., via an interface plug-in), and/or the like, allowing for programmatic interaction between a message filtering interface and an expansion framework 418.

In some embodiments, the expansion framework 418 responds to an expansion request 414 with an expansion response. The expansion response, for example, may comprise an API response (e.g., via an interface plug-in), and/or the like, allowing for programmatic interaction between a message filtering interface and the expansion framework 418. In some examples, the expansion response may comprise an expansion message that comprises an expanded set of target data objects that expand on the initial subset of target data objects 412. An expansion message 416, for example, may comprise a structured data response that comprises the results of an expansion operation performed on a subset of labeled data objects 408 as described with reference to FIG. 5.

In some embodiments, the computing system 101 receives a verification input 422 that comprises a recovery value for an unlabeled data object identified within an expansion message 416. In response to the verification input 422, the computing system 101 may assign (a) a new binary classification label and/or (b) a new quantile rating to the unlabeled data object. In addition, or alternatively, the computing system 101 may store the unlabeled data object as a new labeled data object within the subset of labeled data objects 408.

FIG. 5 depicts a dataflow diagram of an example expansion framework 418 in accordance with some embodiments of the present disclosure. The expansion framework 418 comprises a quantile-based embedding filtering technique that may be implemented by a computing system, such as the computing system 101 of the present disclosure, to adaptively filter target data objects from a set of data objects based on a comparison between an embedding similarity score 510 and one of a set of quantile similarity thresholds 516. In this manner, the expansion framework 418 enables adaptive data expansion that may expand a filtered set of labeled data objects 408 relative quality measures of the filtered data. This allows for expansion messages 416 with a distribution of additional data objects that expands an initially filtered dataset in line with quality metrics thereof.

In some embodiments, the computing system 101 generates a target object embedding 502 for an unlabeled data object of the subset of unlabeled data objects 410 within the set of data objects. In some embodiments, the target object embedding 502 is a vectorized representation of an unlabeled data object. The target object embedding 502, for example, may comprise a numerical representation of an unlabeled data object that captures its essential features in a format suitable for machine learning and/or semantic similarity comparisons. For instance, the target object embedding 502 may comprise one or more dense vectors of floating-point numbers that may be generated using an embedding technique, such as a natural language processing techniques and/or a machine learned encoder model (e.g., Word2Vec, Global Vectors (GloVe), Bidirectional Encoder Representations from Transformers (BERT)). The machine learned encoder model, for example, may comprise an encoder-only language model, such as a neural network (e.g., autoencoder, Siamese network), and/or the like. In some examples, the machine learned encoder model may be trained using a domain-agnostic dataset (e.g., a global language dataset). In addition, or alternatively, the machine learned encoder model may be fine-tuned using a domain-agnostic dataset (e.g., specific to a scenario identifier).

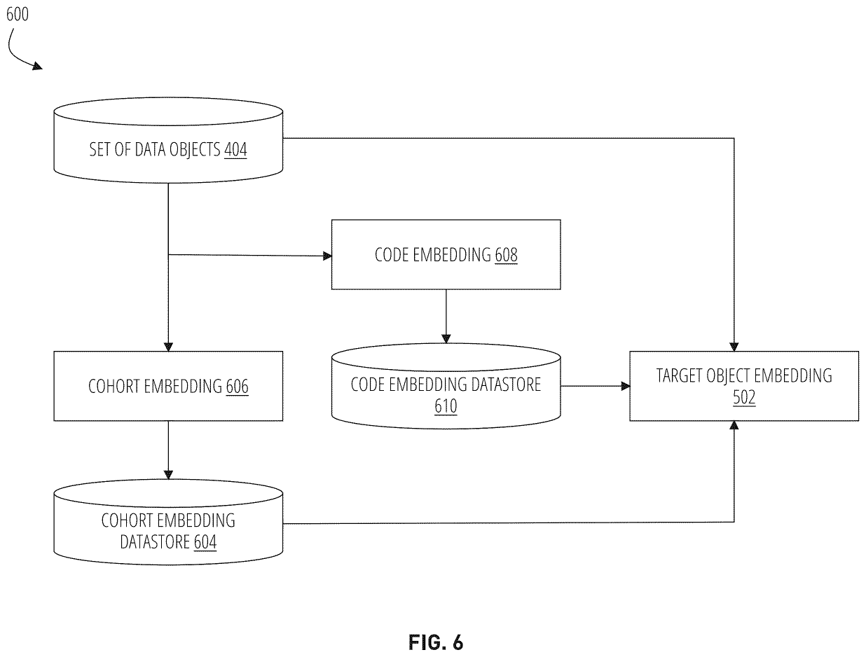

In some examples, the dimensionality of the target object embedding 502 may be based on a set of input features. For example, as described in further detail with reference to FIG. 6, a target object embedding 502 may be generated based on one or more combinations of embeddings derived from one or more object attributes of an unlabeled data object.

As described herein, the set of data objects may comprise a set of labeled data objects 408 and a set of unlabeled data objects 410. In some examples, up to each of the set of labeled data objects 408 may be assigned to one of a set of quantile ratings 506 to configured one or more expansion boundaries for the expansion framework 418 of the present disclosure. For example, the computing system 101 may generate the subset of labeled data objects 408 by assigning a respective quantile rating to up to each of an initial subset of target data objects 412 identified in a preceding filtering subtask. In this manner, the computing system 101 may generate a subset of labeled data objects 408 that are respectively associated with one of a set of quantile ratings 506 reflective of a quality of the respective labeled data object.

By way of example, the subset of labeled data objects 408 may be respectively associated with a set of recovery values. The computing system 101 may assign the quantile rating to an input data object of the subset of labeled data objects 408 by generating a set of quantile rankings based on the set of recovery values, determining a quantile ranking for the input data object, and assigning the quantile rating based on the quantile ranking. In this manner, the quantile rating for a labeled data object may be one of a set of quantile ratings 506 that respectively corresponds to a set of quantile rankings. In some examples, a computing system 101 may configured one or more expansion boundaries for the expansion framework 418 by adaptively setting a set of quantile similarity thresholds 516 that respective correspond to the set of quantile ratings 506.

In some embodiments, a quantile rating is a tag, attribute, and/or the like that identifies a quantile in which a data object is positioned within the subset of labeled data objects 408. For example, the set of quantile ratings 506 (e.g., 1, 2, 3, 4) may respectively correspond to a set of quantile rankings (e.g., 0-0.25, 0.26-0.5, 0.51-0.75, 0.76-1) that may be derived from any numerical attribute of a labeled data object. The quantile rankings, for example, may comprise statistical measures used to categorize data objects based on their relative position within a distribution of values. By way of example, up to each of the subset of labeled data objects 408 may be divided into a set of quantiles based on their respective recovery values. In this manner, a quantile rating may identify a relative level of impact of a labeled data object compared to the subset of labeled data objects 408.

In some embodiments, the computing system 101 assigns a quantile rating to up to each of the subset of labeled data objects 408. To do so, the computing system 101 may sort and/or rank up to each of the labeled data objects 408 based on a target attribute, such as the recovery value. The computing system 101 may divide the sorted and/or ranked subset of labeled data objects 408 into a set of quantiles, such as a first quantile comprising one or more labeled data objects with recovery values that fall in the range of a 0-0.25 quantile, a second quantile comprising one or more labeled data objects with recovery values that fall in the range of a 0.26-0.5 quantile, a third quantile comprising one or more labeled data objects with recovery values that fall in the range of a 0.51-0.75 quantile, a fourth quantile comprising one or more labeled data objects with recovery values that fall in the range of a 0.76-0.1 quantile, and/or the like. In some examples, up to each of the quantiles may comprise sorted data objects of equal-sized subsets.

In some embodiments, the computing system 101 assigns a quantile rating to up to each labeled data object of the subset of labeled data objects 408 based on a quantile in which the labeled data object is partitioned. The quantile rating, for example, may be assigned as an additional object attribute, metadata, and/or the like. In some examples, a set of quantile ratings 506 may be determined and/or assigned on-the-fly using in-memory data structures and/or algorithms optimized for quick ranking and partitioning. By way of example, the set of quantile ratings 506 may be determined for the subset of labeled data objects 408, in real time, as new labeled data objects are added to the subset of labeled data objects 408. In addition, or alternatively, the subset of labeled data objects 408 may be determined in response to an expansion request.

In some embodiments, up to each quantile rating of the set of quantile ratings 506 corresponds to a quantile similarity threshold 516 tailored for the quantile rating. A quantile similarity threshold, for example, may comprise one of a set of thresholds that is specific to a quantile rating associated with the subset of labeled data objects 408. For example, a quantile similarity threshold may a comprise numerical (e.g., floating-point number) cutoff value (e.g., 0.75, 0.85, 0.95, 0.97, 0.99) that corresponds to a quantile rating. In some examples, the computing system 101 may configure and/or store the set of quantile similarity thresholds 516 in a lookup table, indexed by quantile rating. This allows for efficient retrieval of the appropriate threshold during runtime processing.

In some examples, a quantile similarity threshold 516 may be increased (e.g., to set stricter selection criteria) for a lower quantile ratings 506 and/or decreased (e.g., to ease selection criteria) for a higher quantile ratings 506. By way of example, the set of quantile similarity thresholds 516 may comprise a first quantile similarity threshold (e.g., 0.99, 0.95) for a first quantile rating, a second quantile similarity threshold (e.g., 0.95, 0.90) for a second quantile rating, a third quantile similarity threshold (e.g., 0.90, 0.85) for a third quantile rating, a fourth quantile similarity threshold (e.g., 0.80, 0.75) for a fourth quantile rating, and/or the like. In some examples, up to each of the set of quantile similarity thresholds 516 (e.g., the first, second, third, and fourth) may comprise a different cutoff value. In some examples, up to each of the different cutoff values may decrease as the quantile rating increases. In this manner, a similarity criteria may be reduced for labeled data objects within a higher quantile (e.g., indicating a higher impact) relative to labeled data objects within a lower quantile (e.g., indicating a lower impact). By doing so, the set of quantile similarity thresholds 516 provide a flexible, quantile-specific mechanism of filtering unlabeled data objects based on their relative similarity to labeled objects. By using different thresholds for different quantiles, the system may adjust its sensitivity based on the relative importance and/or rarity of objects in each quantile.

In some embodiments, the computing system 101 generates an embedding similarity score 510 for an unlabeled data object based on a comparison between the target object embedding 502 and a reference object embedding corresponding to a labeled data object of the subset of labeled data objects 408. In some embodiments, the reference object embedding is a vectorized representation of a labeled data object. In some examples, a set of reference object embeddings 508 may be generated and stored for the subset of labeled data objects 408. For example, the set of reference object embeddings 508 may comprise a reference object embedding for up to each labeled data object of the subset of labeled data objects 408. In some examples, up to each of the reference object embeddings 508 may be generated using the same encoding techniques used to encode the target object embedding 502. This, for example, may enable direct comparisons between the reference object embeddings 508 and a target object embedding 502 within an embedding space. In some examples, a target object embedding 502 may be stored as one of the reference target object embeddings 502 in response to a determination of a positive classification prediction and/or recovery value for a corresponding unlabeled data object from the subset of unlabeled data objects 410.

In some embodiments, the embedding similarity score 510 is value that quantifies a degree of similarity and/or dissimilarity between two data objects based on a comparison between their respective embeddings. By way of example, an embedding similarity score 510 may be determined between a labeled data object and an unlabeled data object based on an embedding comparison between a reference object embedding and a target object embedding. This allows for various downstream tasks, such as filtering, clustering, classification, recommendation, and/or the like, based on a similarity of the attributes of two data objects as represented within the respective embeddings.

An embedding similarity score 510 may comprise any embedding based similarity comparison, such as a Euclidean distance, cosine similarity, and/or the like. An embedding similarity score 510, for example, may comprise a numerical measure of a similarity (e.g., in terms of distance) of two embeddings within an embedding space. An embedding similarity score 510 may be determined using an embedding similarity function that operates on a pair of vectors. By way of example, the computing system 101 may determine an embedding similarity score 510 by determining a Euclidean distance comprising the square root of the sum of squared differences between corresponding elements of two embedding vectors (e.g., a reference object embedding and a target object embedding). In addition, or alternatively, the computing system 101 may determine the embedding similarity score 510 by determining a cosine similarity comprising a measure of the cosine of the angle between the two embedding vectors (e.g., a reference object embedding and a target object embedding). In this manner

In some embodiments, the computing system 101 determines the unlabeled data object from the subset of unlabeled data objects based on a comparison between the embedding similarity score 510 and a quantile similarity threshold that corresponds to the quantile rating of the labeled data object. For example, the computing system 101 may determine the unlabeled data object as a target data object for an expanded subset of target data objects in the event that the embedding similarity score 510 meets and/or exceeds the quantile similarity threshold corresponding to a matched labeled data object.

A matched labeled data object, for example, may comprise a labeled data object from the subset of labeled data objects 408 that is associated with one or more highest embedding similarity scores relative to other labeled data objects for an unlabeled data object. By way of example, the computing system 101 may determine an embedding similarity score 510 between an unlabeled data object and up to each labeled data object of the subset of labeled data objects 408. In some examples, the matched labeled data object may comprise the labeled data object that is associated with the highest embedding similarity score for an unlabeled data object. In addition, or alternatively, the matched labeled data object may comprise one of a set of matched labeled data objects that is associated with the highest set of embedding similarity scores for the unlabeled data object.

In some embodiments, a target data object comprises an unlabeled data object that meets or exceeds one or more filtering criteria. For instance, the computing system 101 may determine an unlabeled data object as a target data object in the event that an embedding similarity score 510 between the unlabeled data object and a matched labeled data object meets or exceeds a quantile similarity threshold 516 corresponding to the matched labeled data object.

In some embodiments, the computing system 101 provides an expansion message 416 that comprises the unlabeled data object. For example, the expansion message 416 may be provided through an expansion response to an expansion request, as described herein. In some examples, the expansion message 416 may comprise an expanded subset of target data objects that comprises the unlabeled data object and/or one or more additional unlabeled data objects from the subset of unlabeled data objects 410. For instance, the expansion message 416 may comprise a ranking of unlabeled data objects from the subset of unlabeled data objects 410. In some examples, an unlabeled data object may be positioned within the ranking based on the quantile rating of a matched labeled data object.

FIG. 6 depicts a dataflow diagram 600 of an embedding technique in accordance with some embodiments of the present disclosure. The embedding technique may comprise a synthesized embedding approach that may be implemented by a computing system, such as the computing system 101 of the present disclosure, to synthesize vectorized representations of data from multiple data sources to comprehensively represent data objects within a set of data objects. The synthesized embedding approach combines embeddings from different sources, such as cohort embeddings 606 from a cohort embedding datastore 604 and code embeddings from a code embedding datastore 610, to represent a data object at both cohort and entity level. This enables correlations between data objects based on both their individual and shared characteristics. By doing so, the synthesized embedding approach enables more feature-dense representations that better capture semantic details of a data object. Ultimately, this improves the accuracy of downstream embedding comparisons that may empower some of the data expansion techniques of the present disclosure.

In some embodiments, the computing system 101 generates the target object embedding 502 for an unlabeled data object based on a set of object features that comprises the cohort embedding 606, one or more code embeddings 608, and/or one or more code attributes. By way of example, the set of object features may comprise at least one of a cohort embedding 606, a code embedding 608 corresponding to a defined code within a code ontology, a code attribute associated with the defined code, and/or a count of defined codes from the code ontology that are detected within the unlabeled data object.

In some embodiments, an object feature is a numerical feature derived from one or more attributes of a data object within a set of data objects 404. Up to each of a set of object features for a data object may comprise a quantitative representation of one or more characteristics and/or attributes of a data object, designed to capture relevant information in a format suitable for computational analysis. Up to each of a set of object features, for example, may be determined from a data object based on one or more object attributes of the data object. By way of example, an object feature may comprise a cohort embedding 606 that may be generated and/or received from a cohort embedding datastore 604 based on a cohort identifier of a data object. As another example, an object feature may comprise one or more code embeddings 608 that may be generated and/or received from a code embedding datastore 610 based on one or more code identifiers of the data object. In addition, or alternatively, an object feature may comprise one or more numerical code attributes that may be determined based on one or more code attributes of the data object.

In some examples, an object feature may comprise a data value and/or a set of data values (e.g., array, vectors). The object features for a particular data object may be determined in real time and/or precomputed and retrieved based on an identifier within the data object. By way of example, the computing system 101 may comprise and/or have access to one or more embedding datastores that comprise a set of precomputed embeddings associated with a particular object attribute. The embedding datastores, for example, may comprise a code embedding datastore 610 that comprises a set of code embeddings 608 respectively corresponding to a set of defined codes within a code ontology. In addition, or alternatively, the embedding datastores may comprise a cohort embedding datastore 604 that comprises a set of cohort embeddings 606 respectively corresponding to a set of cohorts each associated with one or more data objects.

In some embodiments, the computing system 101 generates the target object embedding 502 for the unlabeled data object by receiving and/or concatenating the set of object features from the data object, the code embedding datastore 610, and/or the cohort embedding datastore 604. By way of example, the computing system 101 may receive (a) a cohort embedding 606 from the cohort embedding datastore 604 that corresponds to a cohort identifier, (b) one or more code embeddings 608 from the code embedding datastore 610 that respectively correspond to one or more code identifiers, and/or determine one or more numerical code attributes that respectively correspond to one or more code attributes of the data object. The computing system 101 may concatenate the set of object features in accordance with a defined feature sequence to generate the target object embedding 502. In this manner, the object features may provide arrangeable units of a structured, numerical representation of a data object that may be interpreted, retrieved, and/or combined, in near-real time, to comprehensively represent a data object. By encoding complex attributes into numerical features, the object features enable quantitative comparisons between objects and facilitate tasks, such as filtering, similarity matching, clustering, classification, and/or the like.

In some embodiments, the computing system 101 receives a cohort embedding 606 for an unlabeled data object from a cohort embedding datastore 604. The cohort embedding 606, for example, may correspond to a cohort identifier associated with a cohort subset of the set of data objects that comprises the unlabeled data object.

In some embodiments, a cohort embedding 606 comprises a vectorized representation of a cohort of data objects associated with a common identifier. The common identifier may depend on the scenario. In a clinical scenario, for example, the common identifier may identify a health care provider associated with a group of medical claims. As another example, in a computer security scenario, a common identifier may identify a software application associated with a set of potential security vulnerabilities. In any scenario, the cohort embedding 606 may comprise a vectorized representation of one or more attributes of a particular cohort.

By way of example, in a clinical use case, a cohort embedding 606 may comprise a vectorized representation of a frequency of a code and/or a requested reimbursement for each of the codes across a set of historical medical claims associated with a healthcare provider. For instance, the computing system 101 may receive a set of historical data objects associated with a health care provider and generate a pivot table in which up to each row represents a specific provider, up to each column represents a specific medical code, and up to each element represents an allowed amount for each provider-code combination. In some example, the computing system 101 may generate, using the pivot table and/or collaborative filtering approaches, such as neural networks, non-negative matrix factorization, singular value decomposition, the cohort embedding for a particular provider based on the historical amounts of the codes within a set of data objects associated with the provider. In this way, the cohort embedding 606 may capture the provider characteristics (e.g., codes they perform and/or the corresponding amounts associated with them) to act as a proxy for a provider contract.

In some embodiments, the computing system 101 receives a code embedding 608 for the unlabeled data object from a code embedding datastore 610. The computing system 101 may receive one or more code embeddings based on one or more defined codes within the unlabeled data object. For instance, the computing system 101 may receive a code embedding for up to each defined code within the unlabeled data object.

In some embodiments, a code embedding 608 comprises a vectorized representation of a defined code that is defined within a code ontology. In some examples, the code embedding 608 may comprise be determined using an encoder, such as BERT, and/or the like, to generate an embedding from a textual description of the defined code. A code embedding 608, for example, may comprise a dense vector representation of a specific code (e.g., a medical procedure code, diagnosis code) that captures semantic information about the code based on its textual description. More generally, a code embedding 608 may comprise a fixed-length vector of floating-point numbers that may be generated using natural language processing (NLP) models; encoder(s), such as Word2Vec, BERT, etc.; and/or the like. The computing system 101 may generate a code embedding 608 for up to each defined code within a code ontology may applying a selected technique to textual description associated with up to each of the defined codes. In some embodiments, up to each of the code embeddings 608 may be stored within a code embedding datastore 610 to facilitate quick retrieval of code embeddings 608 for a target object embedding 502. For instance, up to each of a set of defined codes within a code ontology may be stored in association with a corresponding code embedding within the code embedding datastore 610.

In some embodiments, the defined code is a code defined within a code ontology. The defined code may represent one or more different concepts in a concise, computer interpretable manner. For example, a defined code may comprise an alphanumeric string that follows a specific format defined by a code ontology. A defined code, for example, may comprise a standardized identifier that represents a specific concept within a structured coding system and/or ontology. The concepts may depend on the scenario. By way of example, in a clinical scenario, a defined code may comprise a medical code, such a CPT code representing a clinical procedure, an ICD code representing a codified disease, and/or the like. As another example, in a computer security scenario, a defined code may correspond to an International Organization for Standardization (ISO) code, and/or the like.

In some embodiments, a code ontology comprises an ontology of defined codes for a particular scenario. A code ontology, for example, may comprise a data structure, such as a graph database, relational database, and/or the like, where a set of defined codes may be represented as nodes, data entries, and/or the like. In some examples, the code ontology may further comprise one or more edges, pointers, and/or the like that may represent hierarchical relationships between defined codes of the code ontology. In some examples, the defined codes and/or relationships therebetween may correspond to a particular scenario. By way of example, in a clinical scenario, a code ontology may correspond to CPT ontology, an ICD ontology, and/or the like. As another example, in a computer security scenario, the code ontology may correspond to an ISO ontology, and/or the like.

In some embodiments, the computing system 101 determines one or more code attributes for the unlabeled data object based on the one or more defined codes within the unlabeled data object. A code attribute, for example, may comprise a numerical value that describes one or more characteristics of a defined code within a data object. For instance, a code attribute may comprise numerical summary of one or more financial and/or quantitative aspects associated with specific codes within a data object. By way of example, a code attribute may comprise an aggregate of an allowed amount (minimum, mean, maximum, total) for the define code within the data object. In addition, or alternatively, a code attribute may comprise a total number of defined codes within the data object.

In some embodiments, the computing system 101 generates the target object embedding 502 by concatenating, grouping, and/or otherwise structuring the set of object features in accordance with a defined feature sequence.

In some embodiments, the defined feature sequence comprises a ruleset for combining different object features for a data object within one, comprehensive vector (e.g., a target object embedding 502). A defined feature sequence, for example, may comprise a structured approach to creating a unified representation of a data object by combining various numerical features in a specific order and/or manner. In some examples, a defined feature sequence may comprise a set of instructions that specify how to construct the final vector representation. This might involve operations such as concatenation, weighted averaging, and/or more complex transformations of individual features, such as processing by a feedforward neural network, addition and/or normalization layer, a linear projection layer, and/or a softmax layer. By way of example, the defined feature sequence may define an order of concatenating a set of object features, such that the set of object features may be ordered according to (1) an average of code embeddings 608 of the defined codes present in the data object, (2) a first code attribute (e.g., aggregates of the allowed amounts, such as a min, mean, max, sum), (3) a cohort embedding 606, and/or (4) a second code attribute (e.g., a number defined codes).

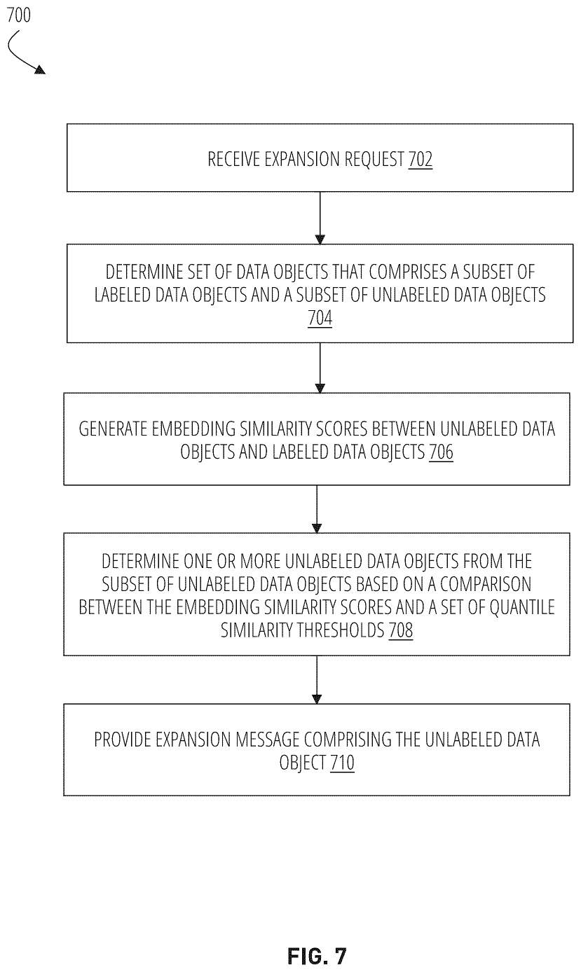

FIG. 7 is a flowchart diagram of an example data filtering and expansion process 700 in accordance with some embodiments of the present disclosure. The flowchart diagram depicts an improved filtering approach that improves the comprehensiveness of tradition data filtering outputs. The process 700 may be implemented by one or more computing devices, entities, and/or systems described herein. For example, via the various steps/operations of the process 700, the computing system 101 may execute sequential processing sub-tasks to first filter and then expand a set of target data objects from a set of data objects for a particular scenario. By doing so, the process 700 improves computer functionality by improving retrieval comprehensiveness in query systems, while maintaining retrieval accuracy compared with traditional data filtering techniques. Moreover, the data filtering and expansion process 700 enable an expansion of filtered data objects downstream of any filtering technique and, by doing so, minimizes information loss from any traditional filtering tool of the expanse.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 comprises, at operation 702, receiving an expansion request. For example, the computing system 101 may receive an expansion request that comprises a scenario identifier.

In some embodiments, the process 700 comprises, at operation 704, determining a set of data objects that comprises a subset of labeled data objects and a subset of unlabeled data objects. For example, the computing system 101 may determine the set of data objects based on the scenario identifier.

In some examples, the set of data objects comprises a subset of unlabeled data objects and/or a subset of labeled data objects. A labeled data object of the subset of labeled data objects may be assigned (i) a binary classification label and/or (ii) a quantile rating that identifies a relative prioritization of the labeled data object relative to the subset of labeled data objects. In some examples, the computing system 101 may generate, using a binary classification model, a positive classification prediction for an input data object of the set of data objects. The computing system 101 may receive a recovery value for the input data object and generate the labeled data object by assigning the binary classification label and/or the quantile rating to the input data object based on the recovery value. By way of example, the subset of labeled data objects may be respectively associated with a set of recovery values. The computing system may assign the quantile rating to the input data object by generating a set of quantile rankings based on the set of recovery values, determining a quantile ranking for the input data object from the set of quantile rankings based on the recovery value, and assigning the quantile rating based on the quantile ranking. In some examples, the quantile rating may be one of a set of quantile ratings that respectively corresponds to the set of quantile rankings.

In some examples, the computing system 101 may determine an initial subset of target data objects from the set of data objects based on the scenario identifier. The computing system 101 may determine the subset of labeled data objects by determining a respective quantile rating associated with up to each of the initial subset of target data objects and, in response to the expansion request, the computing system 101 may determine an expanded subset of target data objects from the set of data objects based on the initial subset of target data objects. In some examples, the expanded subset of target data objects may comprise one or more unlabeled data object.

In some embodiments, the process 700 comprises, at operation 706, generating embedding similarity scores between unlabeled data objects and labeled data objects. For example, the computing system 101 may generate a target object embedding for an unlabeled data object within the set of data objects. To do so, the computing system 101 may receive a cohort embedding for the unlabeled data object that corresponds to a cohort identifier associated with a cohort subset of the set of data objects that comprises the unlabeled data object. In some examples, the computing system 101 may generate the target object embedding for the unlabeled data object based on a set of object features that comprises the cohort embedding. In some examples, the set of object features may further comprise at least one code embedding corresponding to a defined code within a code ontology, a code attribute associated with the defined code, and/or a count of defined codes from the code ontology that are detected within the unlabeled data object. In some examples, the computing system 101 may generate the target object embedding for the unlabeled data object by concatenating the set of object features based on a defined feature sequence and encoding the concatenated set of object features.

The computing system 101 may generate an embedding similarity score for the unlabeled data object based on at least one of an angle or a distance between the target object embedding and a reference object embedding corresponding to the labeled data object.

In some embodiments, the process 700 comprises, at operation 708, determining one or more unlabeled data objects from the subset of unlabeled data objects based on a comparison between the embedding similarity scores and a set of quantile similarity thresholds. For example, the computing system 101 may determine the unlabeled data object from the subset of unlabeled data objects based on the embedding similarity score. In some examples, the quantile similarity threshold is one of a set of quantile similarity thresholds and the set of quantile similarity thresholds may respectively correspond to the set of quantile rankings. In some examples, the quantile rating is one of a set of quantile ratings and the set of quantile ratings may respectively correspond to the set of quantile rankings.

In some embodiments, the process 700 comprises, at operation 710, providing expansion message comprising the unlabeled data object. For example, the computing system 101 may provide the expansion message that comprises the unlabeled data object. In some examples, the expansion message comprises an expansion response to the expansion request. The expansion message may comprise an expanded subset of target data objects. In some examples, the expanded subset of target data object may comprise a ranking of unlabeled data objects from the subset of unlabeled data objects. An unlabeled data object may be positioned within the ranking based on the quantile rating of a corresponding labeled data object.

In some embodiments, the computing system 101 receives a verification input that comprises a recovery value for the unlabeled data object. In response to the verification input, the computing system 101 may (i) assign (a) a new binary classification label and/or (b) a new quantile rating to the unlabeled data object and/or (ii) store the unlabeled data object as a new labeled data object.

Some techniques of the present disclosure enable the generation of action outputs that may be performed to initiate one or more real world actions to achieve real-world effects. The techniques of the present disclosure may be used, applied, and/or otherwise leveraged to filter data messages. In some examples, the filtered messages of the present disclosure may trigger action outputs (e.g., through control instructions) to automate various actions, comprising medical interventions, computer restarts, and/or the like, depending on the scenario. The action outputs may control various aspects of a client device, such as the display, transmission, and/or the like of data reflective of an alert, and/or the like. The alert may be automatically communicated to a user and/or may be used to initiate a security protocol (e.g., locking a computer), a robotic action (e.g., performing an automated screening process), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. CONCLUSION

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as comprising logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model comprising one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.

Example 1. A computer-implemented method comprising generating, by one or more processors, a target object embedding for an unlabeled data object within a set of data objects that comprise a subset of unlabeled data objects and a subset of labeled data objects, wherein a labeled data object of the subset of labeled data objects is assigned (i) a binary classification label and (ii) a quantile rating that identifies a relative prioritization of the labeled data object relative to the subset of labeled data objects; generating, by the one or more processors, an embedding similarity score for the unlabeled data object based on at least one of an angle or a distance between the target object embedding and a reference object embedding corresponding to the labeled data object; determining, by the one or more processors, the unlabeled data object from the subset of unlabeled data objects based on the embedding similarity score and a quantile similarity threshold that corresponds to the quantile rating of the labeled data object; and providing, by the one or more processors, an expansion message that comprises the unlabeled data object.

Example 2. The computer-implemented method of example 1, further comprising generating, using a binary classification model, a positive classification prediction for an input data object of the set of data objects; receiving a recovery value for the input data object; and generating the labeled data object by assigning the binary classification label and the quantile rating to the input data object based on the recovery value.

Example 3. The computer-implemented method of example 2, wherein the subset of labeled data objects is respectively associated with a set of recovery values and assigning the quantile rating to the input data object comprises generating a set of quantile rankings based on the set of recovery values; determining a quantile ranking for the input data object from the set of quantile rankings based on the recovery value; and assigning the quantile rating based on the quantile ranking.

Example 4. The computer-implemented method of example 3, wherein the quantile rating is one of a set of quantile ratings, the set of quantile ratings respectively corresponds to the set of quantile rankings, the quantile similarity threshold is one of a set of quantile similarity thresholds, and the set of quantile similarity thresholds respectively corresponds to the set of quantile rankings.

Example 5. The computer-implemented method of any of the preceding examples, wherein generating the target object embedding comprises receiving a cohort embedding for the unlabeled data object that corresponds to a cohort identifier associated with a cohort subset of the set of data objects that comprises the unlabeled data object; and generating the target object embedding for the unlabeled data object based on a set of object features that comprises the cohort embedding.

Example 6. The computer-implemented method of example 5, wherein the set of object features further comprise at least one code embedding corresponding to a defined code within a code ontology, a code attribute associated with the defined code, or a count of defined codes from the code ontology that are detected within the unlabeled data object.

Example 7. The computer-implemented method of any of examples 5 or 6, wherein generating the target object embedding for the unlabeled data object comprises concatenating the set of object features based on a defined feature sequence and encoding the concatenated set of object features.

Example 8. The computer-implemented method of any of the preceding examples, wherein the expansion message comprises an expansion response to an expansion request and the computer-implemented method further comprises receiving a scenario identifier; determining an initial subset of target data objects from the set of data objects based on the scenario identifier; generating the subset of labeled data objects by determining a respective quantile rating associated with up to each of the initial subset of target data objects; and in response to the expansion request, determining an expanded subset of target data objects from the set of data objects based on the initial subset of target data objects, wherein the expanded subset of target data objects comprises the unlabeled data object.

Example 9. The computer-implemented method of example 8, wherein the expanded subset of target data objects comprises a ranking of unlabeled data objects from the subset of unlabeled data objects and the unlabeled data object is positioned within the ranking based on the quantile rating of the labeled data object.

Example 10. The computer-implemented method of any of the preceding examples, further comprising receiving a verification input that comprise a recovery value for the unlabeled data object; and in response to the verification input, (i) assigning (a) a new binary classification label and (b) a new quantile rating to the unlabeled data object and (ii) storing the unlabeled data object as a new labeled data object.

Example 11. A system comprising one or more processors; and one or more memories storing processor-executable instructions that, when executed by the one or more processors, cause the one or more processors to perform operations comprising generating a target object embedding for an unlabeled data object within a set of data objects that comprise a subset of unlabeled data objects and a subset of labeled data objects, wherein a labeled data object of the subset of labeled data objects is assigned (i) a binary classification label and (ii) a quantile rating that identifies a relative prioritization of the labeled data object relative to the subset of labeled data objects; generating an embedding similarity score for the unlabeled data object based on at least one of an angle or a distance between the target object embedding and a reference object embedding corresponding to the labeled data object; determining the unlabeled data object from the subset of unlabeled data objects based on the embedding similarity score and a quantile similarity threshold that corresponds to the quantile rating of the labeled data object; and providing an expansion message that comprises the unlabeled data object.

Example 12. The system of example 11, wherein the operations further comprise generating, using a binary classification model, a positive classification prediction for an input data object of the set of data objects; receiving a recovery value for the input data object; and generating the labeled data object by assigning the binary classification label and the quantile rating to the input data object based on the recovery value.

Example 13. The system of example 12, wherein the subset of labeled data objects is respectively associated with a set of recovery values and assigning the quantile rating to the input data object comprises generating a set of quantile rankings based on the set of recovery values; determining a quantile ranking for the input data object from the set of quantile rankings based on the recovery value; and assigning the quantile rating based on the quantile ranking.

Example 14. The system of example 13, wherein the quantile rating is one of a set of quantile ratings, the set of quantile ratings respectively corresponds to the set of quantile rankings, the quantile similarity threshold is one of a set of quantile similarity thresholds, and the set of quantile similarity thresholds respectively corresponds to the set of quantile rankings.

Example 15. The system of any of examples 11 through 14, wherein generating the target object embedding comprises receiving a cohort embedding for the unlabeled data object that corresponds to a cohort identifier associated with a cohort subset of the set of data objects that comprises the unlabeled data object; and generating the target object embedding for the unlabeled data object based on a set of object features that comprises the cohort embedding.

Example 16. The system of example 15, wherein the set of object features further comprise at least one code embedding corresponding to a defined code within a code ontology, a code attribute associated with the defined code, or a count of defined codes from the code ontology that are detected within the unlabeled data object.

Example 17. One or more non-transitory computer-readable media storing processor-executable instructions that, when executed by one or more processors, cause the one or more processors to perform operations comprising generating a target object embedding for an unlabeled data object within a set of data objects that comprise a subset of unlabeled data objects and a subset of labeled data objects, wherein a labeled data object of the subset of labeled data objects is assigned (i) a binary classification label and (ii) a quantile rating that identifies a relative prioritization of the labeled data object relative to the subset of labeled data objects; generating an embedding similarity score for the unlabeled data object based on at least one of an angle or a distance between the target object embedding and a reference object embedding corresponding to the labeled data object; determining the unlabeled data object from the subset of unlabeled data objects based on the embedding similarity score and a quantile similarity threshold that corresponds to the quantile rating of the labeled data object; and providing an expansion message that comprises the unlabeled data object.

Example 18. The one or more non-transitory computer-readable media of example 17, wherein the expansion message comprises an expansion response to an expansion request and the computer-implemented method further comprises receiving a scenario identifier; determining an initial subset of target data objects from the set of data objects based on the scenario identifier; generating the subset of labeled data objects by determining a respective quantile rating associated with up to each of the initial subset of target data objects; and in response to the expansion request, determining an expanded subset of target data objects from the set of data objects based on the initial subset of target data objects, wherein the expanded subset of target data objects comprises the unlabeled data object.

Example 19. The one or more non-transitory computer-readable media of example 18, wherein the expanded subset of target data objects comprises a ranking of unlabeled data objects from the subset of unlabeled data objects and the unlabeled data object is positioned within the ranking based on the quantile rating of the labeled data object.

Example 20. The one or more non-transitory computer-readable media of any of examples 18 through 19, wherein the operations further comprise receiving a verification input that comprise a recovery value for the unlabeled data object; and in response to the verification input, (i) assigning (a) a new binary classification label and (b) a new quantile rating to the unlabeled data object and (ii) storing the unlabeled data object as a new labeled data object.

1. A computer-implemented method comprising:
generating, by one or more processors, a target object embedding for an unlabeled data object within a set of data objects that comprise a subset of unlabeled data objects and a subset of labeled data objects, wherein (i) a labeled data object of the subset of labeled data objects is assigned (a) a binary classification label and (b) a quantile rating of a set of quantile ratings that identifies a relative position of the labeled data object relative to the subset of labeled data objects and (ii) the set of quantile ratings respectively corresponds to a set of quantile rankings;
generating, by the one or more processors, an embedding similarity score for the unlabeled data object based on at least one of an angle or a distance between the target object embedding and a reference object embedding corresponding to the labeled data object;
determining, by the one or more processors, the unlabeled data object from the subset of unlabeled data objects based on the embedding similarity score and a quantile similarity threshold that corresponds to the quantile rating of the labeled data object; and
providing, by the one or more processors, an expansion message that comprises the unlabeled data object.

2. The computer-implemented method of claim 1, further comprising:
generating, using a binary classification model, a positive classification prediction for an input data object of the set of data objects;
receiving a recovery value for the input data object; and
generating the labeled data object by assigning the binary classification label and the quantile rating to the input data object based on the recovery value.

3. The computer-implemented method of claim 2, wherein the subset of labeled data objects is respectively associated with a set of recovery values and assigning the quantile rating to the input data object comprises:
generating a set of quantile rankings based on the set of recovery values;
determining a quantile ranking for the input data object from the set of quantile rankings based on the recovery value; and
assigning the quantile rating based on the quantile ranking.

4. The computer-implemented method of claim 3, wherein the quantile rating is one of a set of quantile ratings, the set of quantile ratings respectively corresponds to the set of quantile rankings, the quantile similarity threshold is one of a set of quantile similarity thresholds, and the set of quantile similarity thresholds respectively corresponds to the set of quantile rankings.

5. The computer-implemented method of claim 1, wherein generating the target object embedding comprises:
receiving a cohort embedding for the unlabeled data object that corresponds to a cohort identifier associated with a cohort subset of the set of data objects that comprises the unlabeled data object; and
generating the target object embedding for the unlabeled data object based on a set of object features that comprises the cohort embedding.

6. The computer-implemented method of claim 5, wherein the set of object features further comprise at least one code embedding corresponding to a defined code within a code ontology, a code attribute associated with the defined code, or a count of defined codes from the code ontology that are detected within the unlabeled data object.

7. The computer-implemented method of claim 5, wherein generating the target object embedding for the unlabeled data object comprises concatenating the set of object features based on a defined feature sequence and encoding the concatenated set of object features.

8. The computer-implemented method of claim 1, wherein the expansion message comprises an expansion response to an expansion request and the computer-implemented method further comprises:
receiving a scenario identifier;
determining an initial subset of target data objects from the set of data objects based on the scenario identifier;
generating the subset of labeled data objects by determining a respective quantile rating associated with up to each of the initial subset of target data objects; and
in response to the expansion request, determining an expanded subset of target data objects from the set of data objects based on the initial subset of target data objects, wherein the expanded subset of target data objects comprises the unlabeled data object.

9. The computer-implemented method of claim 8, wherein the expanded subset of target data objects comprises a ranking of unlabeled data objects from the subset of unlabeled data objects and the unlabeled data object is positioned within the ranking based on the quantile rating of the labeled data object.

10. The computer-implemented method of claim 1, further comprising:
receiving a verification input that comprise a recovery value for the unlabeled data object; and
in response to the verification input, (i) assigning (a) a new binary classification label and (b) a new quantile rating to the unlabeled data object and (ii) storing the unlabeled data object as a new labeled data object.

11. A system comprising:
one or more processors; and
one or more memories storing processor-executable instructions that, when executed by the one or more processors, cause the one or more processors to:
generate a target object embedding for an unlabeled data object within a set of data objects that comprise a subset of unlabeled data objects and a subset of labeled data objects, wherein (i) a labeled data object of the subset of labeled data objects is assigned (a) a binary classification label and (b) a quantile rating of a set of quantile ratings that identifies a relative position of the labeled data object relative to the subset of labeled data objects and (ii) the set of quantile ratings respectively corresponds to a set of quantile rankings;
generate an embedding similarity score for the unlabeled data object based on at least one of an angle or a distance between the target object embedding and a reference object embedding corresponding to the labeled data object;
determine the unlabeled data object from the subset of unlabeled data objects based on the embedding similarity score and a quantile similarity threshold that corresponds to the quantile rating of the labeled data object; and
provide an expansion message that comprises the unlabeled data object.

12. The system of claim 11, wherein the one or more processors are further caused to:
generate, using a binary classification model, a positive classification prediction for an input data object of the set of data objects;
receive a recovery value for the input data object; and
generate the labeled data object by assigning the binary classification label and the quantile rating to the input data object based on the recovery value.

13. The system of claim 12, wherein the subset of labeled data objects is respectively associated with a set of recovery values and assigning the quantile rating to the input data object comprises:
generating a set of quantile rankings based on the set of recovery values;
determining a quantile ranking for the input data object from the set of quantile rankings based on the recovery value; and
assigning the quantile rating based on the quantile ranking.

14. The system of claim 13, wherein the quantile rating is one of a set of quantile ratings, the set of quantile ratings respectively corresponds to the set of quantile rankings, the quantile similarity threshold is one of a set of quantile similarity thresholds, and the set of quantile similarity thresholds respectively corresponds to the set of quantile rankings.

15. The system of claim 11, wherein generating the target object embedding comprises:
receiving a cohort embedding for the unlabeled data object that corresponds to a cohort identifier associated with a cohort subset of the set of data objects that comprises the unlabeled data object; and
generating the target object embedding for the unlabeled data object based on a set of object features that comprises the cohort embedding.

16. The system of claim 15, wherein the set of object features further comprise at least one code embedding corresponding to a defined code within a code ontology, a code attribute associated with the defined code, or a count of defined codes from the code ontology that are detected within the unlabeled data object.

17. One or more non-transitory computer-readable storage media including instructions that, when executed by one or more processors, cause the one or more processors to:
generate a target object embedding for an unlabeled data object within a set of data objects that comprise a subset of unlabeled data objects and a subset of labeled data objects, wherein (i) a labeled data object of the subset of labeled data objects is assigned (a) a binary classification label and (b) a quantile rating of a set of quantile ratings that identifies a relative position of the labeled data object relative to the subset of labeled data objects and (ii) the set of quantile ratings respectively corresponds to a set of quantile rankings;
generate an embedding similarity score for the unlabeled data object based on at least one of an angle or a distance between the target object embedding and a reference object embedding corresponding to the labeled data object;
determine the unlabeled data object from the subset of unlabeled data objects based on the embedding similarity score and a quantile similarity threshold that corresponds to the quantile rating of the labeled data object; and
provide an expansion message that comprises the unlabeled data object.

18. The one or more non-transitory computer-readable storage media of claim 17, wherein the expansion message comprises an expansion response to an expansion request and the one or more processors are further caused to:
receive a scenario identifier;
determine an initial subset of target data objects from the set of data objects based on the scenario identifier;
generate the subset of labeled data objects by determining a respective quantile rating associated with up to each of the initial subset of target data objects; and
in response to the expansion request, determine an expanded subset of target data objects from the set of data objects based on the initial subset of target data objects, wherein the expanded subset of target data objects comprises the unlabeled data object.

19. The one or more non-transitory computer-readable storage media of claim 18, wherein the expanded subset of target data objects comprises a ranking of unlabeled data objects from the subset of unlabeled data objects and the unlabeled data object is positioned within the ranking based on the quantile rating of the labeled data object.

20. The one or more non-transitory computer-readable storage media of claim 18, wherein the one or more processors are further caused to:
receive a verification input that comprise a recovery value for the unlabeled data object; and
in response to the verification input, (i) assign (a) a new binary classification label and (b) a new quantile rating to the unlabeled data object and (ii) store the unlabeled data object as a new labeled data object.
